(19) United States
(12) Patent Application Publication
(10) Pub. No.: US 2013/0032682 A1
(43) Pub. Date: Feb. 7, 2013

(54) SCISSOR LINKAGE MECHANISM

(71) Applicant: Matthew A. BELL, Jamestown, NY (US)

(72) Inventor: Matthew A. BELL, Jamestown, NY (US)

(73) Assignee: Weber Knapp Company, Jamestown, NY (US)

(21) Appl. No.: 13/198,177

(22) Filed: Aug. 4, 2011

(51) Int. Cl. F16M 13/02

(52) U.S. Cl. 248/277.1

(57) ABSTRACT

A mounting apparatus for an object including a rear mounting plate, a linkage system having first, second, third and fourth links, each of the first, second, third and fourth links includes first and second ends, and a swivel assembly. The first end of each of the first and second links is pivotably secured to the rear mounting plate, the second end of each of the third and fourth links is pivotably secured to the swivel assembly, the second end of the first link is pivotably secured to the first end of the third link, and the second end of the second link is pivotably secured to the first end of the fourth link. The linkage system includes a first gear and a second gear, and the first gear is rotatably connected to the second gear.

### FIELD OF THE INVENTION

The invention broadly relates to scissor linkage mechanisms, more specifically to a scissor linkage mechanism for supporting an object such as a flat screen, and even more particularly to a scissor linkage mechanism for supporting an object which provides at least one of the following modifiable orientations: inward and outward movement of the object; side to side movement of the object; and, upward and downward tilting of the object.

### BACKGROUND OF THE INVENTION

Flat screen devices, such as televisions, computer monitors, touch screens, etc., have become common in a variety of settings. For example, flat screen televisions are often secured on a wall via a moveable mount, while flat screen computer monitors are secured to a desk via a similar moveable mount. An advantage of the foregoing flat screen devices is the low profile or thickness of these devices which permits a minimization of the space consumed by using and/or storing the device. For example, a flat screen television may be moved away from a mounting wall and positioned for optimal viewing during use, and returned to a position adjacent to the mounting wall during non-use.

A variety of complex, heavy and expensive devices have been created to provide desired mounting features, e.g., providing multiple degrees of freedom for movement while securely retaining a heavy object. A benefit as well as a drawback of such devices is that the degrees of freedom are not limited. In other words, the flat screen device may be moved and position in orientations that are entirely impractical, e.g., directed fully away from a useable viewing angle.

As can be derived from the variety of devices and methods directed at mounting flat screen devices, many means have been contemplated to accomplish the desired end, i.e., secure mounting of an object while providing a variety of degrees of freedom of motion. Heretofore, tradeoffs between cost and performance were required. Thus, there is a long-felt need for a scissor linkage mechanism for use in mounting flat screen or generally planar devices which is inexpensive to manufacture and provides a variety of degrees of freedom, while limiting the motion of the mounted device to a set of acceptable positions or orientations.

### BRIEF SUMMARY OF THE INVENTION

The present invention broadly comprises a mounting apparatus for an object. The apparatus includes a rear mounting plate, a linkage system having first, second, third and fourth links, each of the first, second, third and fourth links includes first and second ends, and a swivel assembly. The first end of each of the first and second links is pivotably secured to the rear mounting plate, the second end of each of the third and fourth links is pivotably secured to the swivel assembly, the second end of the first link is pivotably secured to the first end of the third link, and the second end of the second link is pivotably secured to the first end of the fourth link. The first end of the first link includes a first gear and the first end of the second link includes a second gear, and the first gear is rotatably connected to the second gear. In some embodiments, the object is secured to the swivel assembly. In some embodiments, the object is selected from the group consisting of: a flat screen television, a computer monitor, a touch screen device and a generally planar object. In some embodiments, the swivel assembly includes a front pivot link pivotably secured a front mounting plate and the second end of each of the third and fourth links is pivotably secured to the front pivot link. In some embodiments, the swivel assembly includes a locking apparatus for releasably securing the front pivot link relative to the front mounting plate. In some embodiments, the locking apparatus includes a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

In a further embodiment, the present invention broadly comprises a mounting apparatus for an object. The mounting apparatus includes a rear mounting plate, a linkage system having first, second, third and fourth links, each of the first, second, third and fourth links includes first and second ends, and a swivel assembly. The first end of each of the first and second links is pivotably secured to the rear mounting plate, the second end of each of the third and fourth links is pivotably secured to the swivel assembly, the second end of the first link is pivotably secured to the first end of the third link, and the second end of the second link is pivotably secured to the first end of the fourth link. The second end of the third link includes a first gear and the second end of the fourth link includes a second gear, and the first gear is rotatably connected to the second gear. In some embodiments, the object is secured to the swivel assembly. In some embodiments, the object is selected from the group consisting of: a flat screen television, a computer monitor, a touch screen device and a generally planar object. In some embodiments, the swivel assembly includes a front pivot link pivotably secured a front mounting plate and the second end of each of the third and fourth links is pivotably secured to the front pivot link. In some embodiments, the swivel assembly includes a locking apparatus for releasably securing the front pivot link relative to the front mounting plate. In some embodiments, the locking apparatus includes a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

In still a further embodiment, the present invention broadly comprises a mounting apparatus for an object. The mounting apparatus includes a rear mounting plate, a linkage system having first, second, third and fourth links, each of the first, second, third and fourth links includes first and second ends, and a swivel assembly. The first end of each of the first and second links is pivotably secured to the rear mounting plate, the second end of each of the third and fourth links is pivotably secured to the swivel assembly, the second end of the first link is pivotably secured to the first end of the third link, and the second end of the second link is pivotably secured to the first end of the fourth link. The first end of the first link includes a first gear, the first end of the second link includes a second gear, the second end of the third link includes a third gear, and the second end of the fourth link includes a fourth gear. The first gear is rotatably connected to the second gear and the third gear is rotatably connected to the fourth gear. In some embodiments, the object is secured to the swivel assembly. In some embodiments, the object is selected from the group consisting of: a flat screen television, a computer monitor, a touch screen device and a generally planar object. In some embodiments, the swivel assembly includes a front pivot link pivotably secured a front mounting plate and the second end of each of the third and fourth links is pivotably secured to the front pivot link. In some embodiments, the swivel assembly includes a locking apparatus for releasably securing the front pivot link relative to the front mounting plate. In some embodiments, the locking apparatus includes a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

In still yet a further embodiment, the present invention broadly comprises a mounting apparatus for an object. The mounting apparatus includes a rear mounting plate, a linkage system having first, second, third and fourth links, each of the first, second, third and fourth links includes first and second ends, and a swivel assembly. The first end of each of the first and second links is pivotably secured to the rear mounting plate, the second end of each of the third and fourth links is pivotably secured to the swivel assembly, the second end of the first link is pivotably secured to the first end of the third link, and the second end of the second link is pivotably secured to the first end of the fourth link. The linkage system includes a first gear and a second gear, and the first gear is rotatably connected to the second gear. In some embodiments, the first end of the first link includes the first gear and the first end of the second link includes the second gear. In some embodiments, the second end of the third link includes the first gear and the second end of the fourth link includes the second gear. In some embodiments, the linkage system further includes a third gear and a fourth gear, and the third gear is rotatably connected to the fourth gear, and, in these embodiments, the first end of the first link includes the first gear, the first end of the second link includes the second gear, the second end of the third link includes the third gear and the second end of the fourth link includes the fourth gear. In some embodiments, the object is secured to the swivel assembly. In some embodiments, the object is selected from the group consisting of: a flat screen television, a computer monitor, a touch screen device and a generally planar object. In some embodiments, the swivel assembly includes a front pivot link pivotably secured a front mounting plate and the second end of each of the third and fourth links is pivotably secured to the front pivot link. In some embodiments, the swivel assembly includes a locking apparatus for releasably securing the front pivot link relative to the front mounting plate. In some embodiments, the locking apparatus includes a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

It is a general object of the present invention to provide a mounting apparatus for an object which includes a fixed set of degrees of freedom of movement, thereby permitting the customization of an object's position while precluding unnecessary orientations.

It is another general object of the present invention to provide a mounting apparatus which maintains a low production cost and a minimum number of components while providing the aforementioned objects.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of an embodiment of a present invention scissor linkage mechanism arranged between a mounting bracket and a flat screen display;

FIG. 2A is a perspective view of an embodiment of a present invention scissor linkage mechanism;

FIG. 2B is an enlarged perspective view of the encircled region 2B shown in

FIG. 2A;

FIG. 3A is a top plan view of an embodiment of a present invention scissor linkage mechanism disposed in a partially extended position and depicting internal elements in broken lines;

FIG. 3B is a side elevational view of the embodiment of the present invention scissor linkage mechanism shown in FIG. 3A depicting internal elements in broken lines;

FIG. 4A is a top plan view of the embodiment of the present invention scissor linkage mechanism shown in FIG. 3A disposed in a fully retracted position and depicting internal elements in broken lines;

FIG. 4B is an enlarged top plan view of the encircled region 4B shown in

FIG. 4A;

FIG. 4C is a top plan view of the embodiment of the present invention scissor linkage mechanism shown in FIG. 3A disposed in a fully extended position and depicting internal elements in broken lines;

FIG. 4D is a top plan view of the embodiment of the present invention scissor linkage mechanism shown in FIG. 3A disposed in a fully extended position, rotated in a clockwise direction and depicting internal elements in broken lines;

FIG. 4E is a top plan view of the embodiment of the present invention scissor linkage mechanism shown in FIG. 3A disposed in a fully extended position, rotated in a counter-clockwise direction and depicting internal elements in broken lines;

FIG. 5A is a top plan view of another embodiment of a present invention scissor linkage mechanism disposed in a fully retracted position and depicting internal elements in broken lines;

FIG. 5B is an enlarged top plan view of the encircled region 5B shown in

FIG. 5A;

FIG. 5C is a top plan view of the embodiment of the present invention scissor linkage mechanism shown in FIG. 5A disposed in a fully extended position and depicting internal elements in broken lines;

FIG. 5D is a top plan view of the embodiment of the present invention scissor linkage mechanism shown in FIG. 5A disposed in a fully extended position, rotated in a clockwise direction and depicting internal elements in broken lines;

FIG. 5E is a top plan view of the embodiment of the present invention scissor linkage mechanism shown in FIG. 5A disposed in a fully extended position, rotated in a counter-clockwise direction and depicting internal elements in broken lines;

FIG. 6A is a top plan view of yet another embodiment of a present invention scissor linkage mechanism disposed in a fully retracted position and depicting internal elements in broken lines;

FIG. 6B is an enlarged top plan view of the encircled region 6B shown in FIG. 6A;

FIG. 6C is a top plan view of the embodiment of the present invention scissor linkage mechanism shown in FIG. 6A disposed in a fully extended position and depicting internal elements in broken lines;

FIG. 7A is a perspective view of an embodiment of a present invention scissor linkage mechanism arranged between a mounting bracket and a flat screen display, and having the flat screen display oriented in a partially upward facing direction;

FIG. 7B is a side elevational view of an embodiment of a present invention scissor linkage mechanism arranged between a mounting bracket and a flat screen display, and having the flat screen display oriented vertically;

FIG. 7C is a side elevational view of an embodiment of a present invention scissor linkage mechanism arranged between a mounting bracket and a flat screen display, and having the flat screen display oriented in a partially downward facing direction;

FIG. 7D is a side elevational view of an embodiment of a present invention scissor linkage mechanism arranged between a mounting bracket and a flat screen display, and having the flat screen display oriented in a partially upward facing direction;

FIG. 8 is a perspective view of an embodiment of a swivel assembly used in a present invention scissor linkage mechanism;

FIG. 9A is a back elevational view of the swivel assembly shown in FIG. 8;

FIG. 9B is a top plan view of the swivel assembly shown in FIG. 8;

FIG. 9C is a side elevational view of the swivel assembly shown in FIG. 8;

FIG. 10A is a side elevational view of a link comprising a first end having a gear and used in some embodiments of a present invention scissor linkage mechanism;

FIG. 10B is a top plan view of the link shown in FIG. 10A;

FIG. 10C is an end elevational view of the link shown in FIG. 10A;

FIG. 11A is a side elevational view of another link used in some embodiments of a present invention scissor linkage mechanism;

FIG. 11B is a top plan view of the link shown in FIG. 11A;

FIG. 11C is an end elevational view of the link shown in FIG. 11A;

FIG. 12A is a back elevational view of a rear mounting plate used in a present invention scissor linkage mechanism;

FIG. 12B is a top plan view of the rear mounting plate shown in FIG. 12A;

FIG. 12C is a side elevational view of the rear mounting plate shown in FIG. 12A;

FIG. 13A is a front elevational view of another embodiment of a swivel assembly used in a present invention scissor linkage mechanism;

FIG. 13B is a top plan view of the swivel assembly shown in FIG. 13A;

FIG. 13C is a side elevational view of the swivel assembly shown in FIG. 13A;

FIG. 14A is a front elevational view of yet another embodiment of a swivel assembly used in a present invention scissor linkage mechanism;

FIG. 14B is a top plan view of the swivel assembly shown in FIG. 14A; and,

FIG. 14C is a side elevational view of the swivel assembly shown in FIG. 14A.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “rotatably connected” as used herein is intended to mean a first element is connected to a second element such that rotation of the first element causes rotation of the second element. Such a connection may be formed by meshed gears, splines or any other known means in the art. Although any methods, devices or materials similar or equivalent to those described herein can be used in the practice or testing of the invention, the preferred methods, devices, and materials are now described.

An embodiment of a present invention scissor linkage mechanism, i.e., mechanism 10 comprises rear mounting plate 12 arranged to be secured to a mounting surface, e.g., a wall, a bracket, etc. Mechanism 10 further comprises linkage 14 and swivel assembly 16. Linkage 14 comprises four discreet links, e.g., links 18a, 18b, 20a and 20b. As is described in greater infra, the links which form linkage 14 may include a variety of configurations and forms depending on the desired performance characteristics of the present invention scissor linkage mechanism. Swivel assembly 16 comprises front pivot link 22, front mounting plate 24, swivel spacer 26, washers 28, 30 and 32, carriage bolt 34 and hex nut 36.

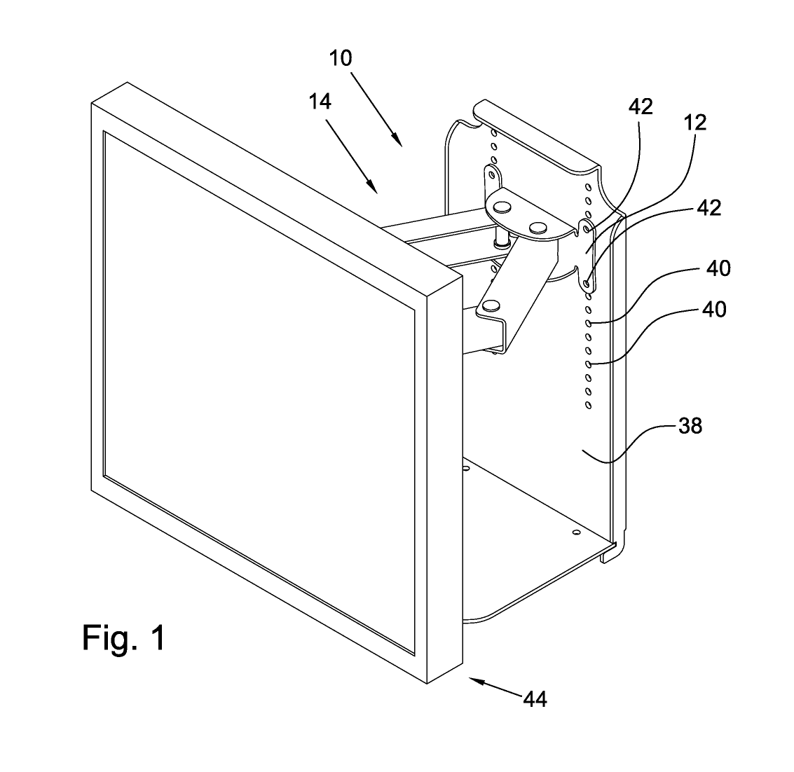

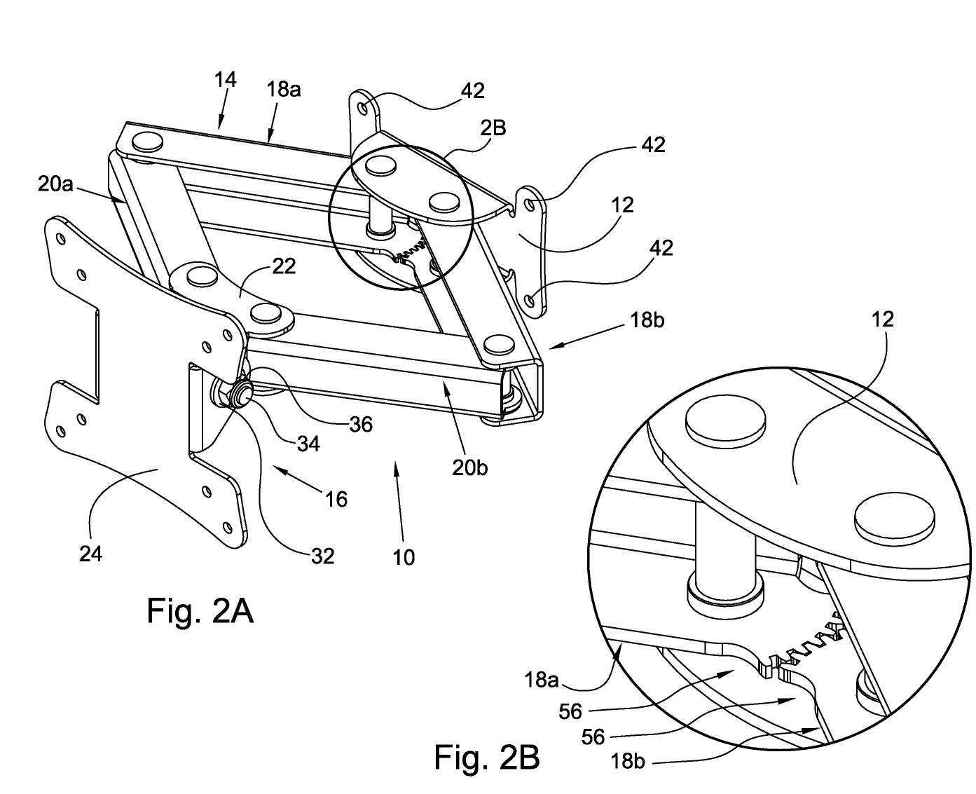

In an embodiment, the present invention scissor linkage mechanism 10 is secured to bracket 38 via rear mounting plate 12. As can be seen in FIG. 1, bracket 38 comprises a plurality of holes 40 arranged to receive a fastener such as a bolt. Rear mounting plate 12 is secured to bracket 38 by passing a bolt (not shown) through each of holes 42 within rear mounting plate 12 and subsequently through the appropriate hole 40 aligned with each hole 42. Then, a nut (not shown) is secured to the threaded end of each bolt thereby securing rear mounting plate 12 to bracket 38. Subsequently, bracket 38 may be affixed to another object, e.g., a wall, a desk, a cabinet, etc. It should be appreciated that depending on how mechanism 10 is intended to be used, the method of securing the bracket may be varied. For example, if bracket 12 is secured to a wall, i.e., bracket 38 is not included, a screw may be inserted through each hole 42 and subsequently affixed to the wall.

As can be appreciated in view of the figures, flat screen monitor 44 may be affixed to swivel assembly 16. It should be further appreciated that a variety of other devices may be affixed to swivel assembly 16 such as a mirror, a touch screen interface, a keyboard, framed photo, generally planar object, etc.

The present invention scissor linkage mechanism may include a variety of arrangements of linkage 14 based upon the desired degrees of the freedom for the object mounted on swivel assembly 16.

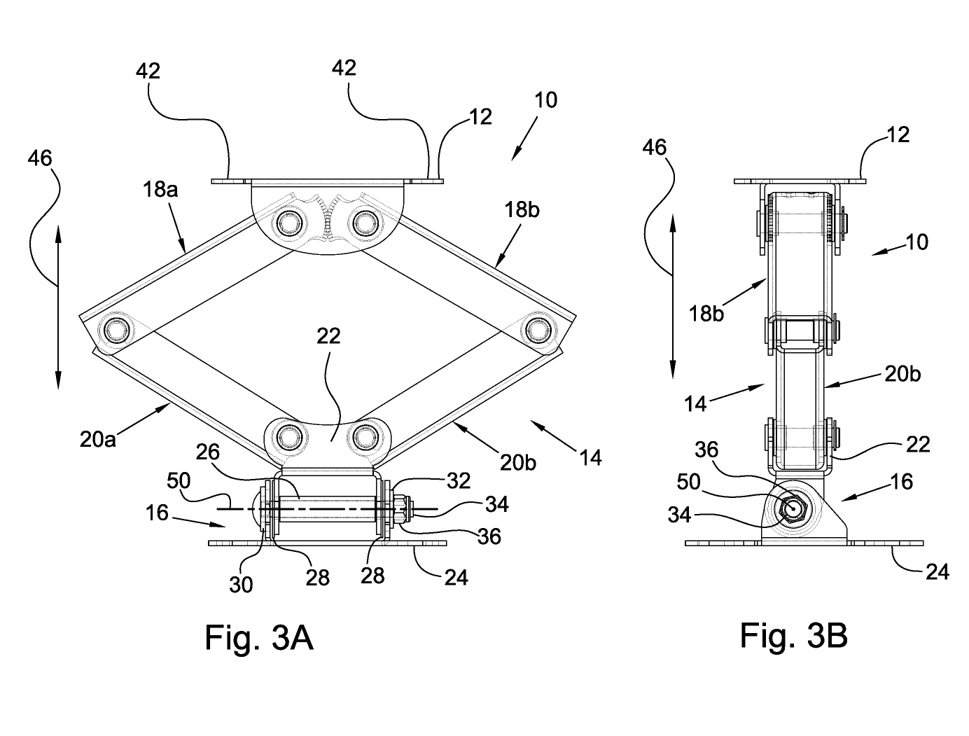

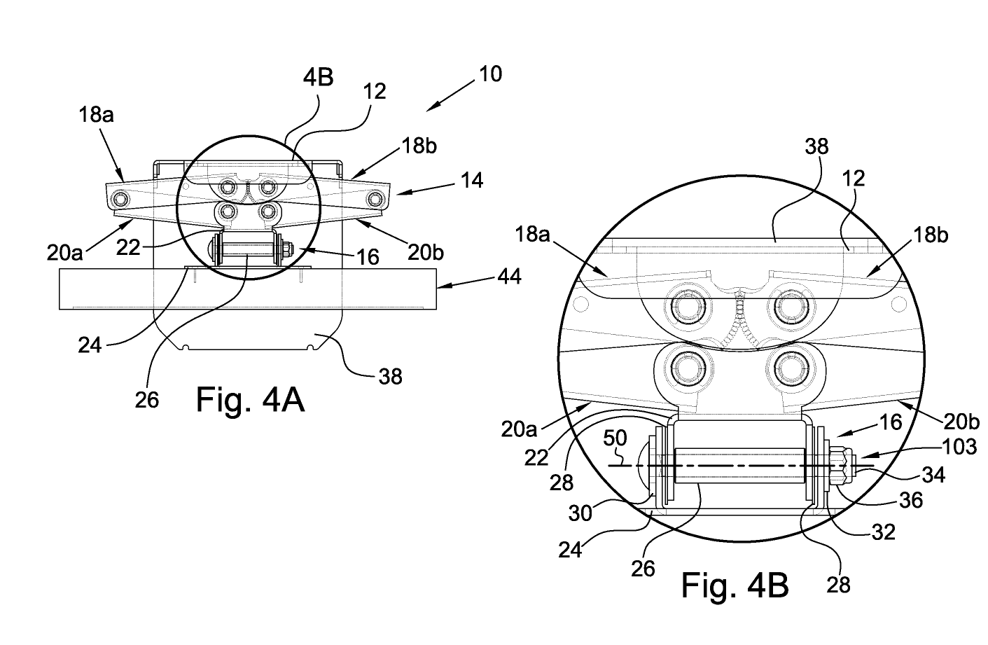

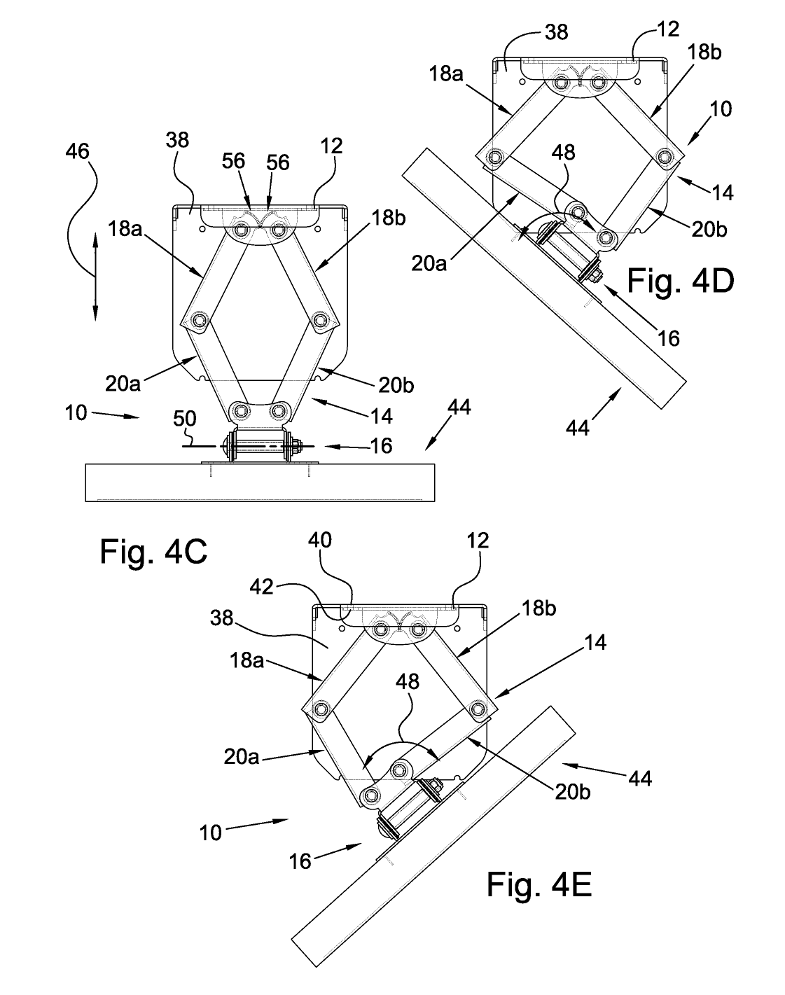

A first embodiment is shown in FIGS. 3A-4E wherein swivel assembly 16 may be moved inwardly and outwardly in the directions represented by bi-directional arrow 46, may pivot, or more particularly rotate and translate, side to side about arcuate bi-directional arrow 48 located proximate swivel assembly 16, and may pivot upwardly and downwardly about axis 50. Such degrees of freedom are provided by the arrangement of links 18a, 18b, 20a and 20b.

Links 18a and 18b each include spaced apart parallel side walls 52a and 52b. At a first end of each of links 18a and 18b, i.e., end 54, each of links 18a and 18b includes geared portion 56. Geared portion 56 may comprise gears 58a and 58b on space apart parallel side walls 52a and 52b, respectively. Alternatively, geared portion 56 may comprise a gear 58a on one of side walls 52a in combination with a gear 58b on one of side walls 52b. Geared portion 56 further comprises through holes 60a and 60b disposed in side walls 52a and 52b, respectively, wherein through holes 60a and 60b are in registered alignment. Each of through holes 60a and 60b are aligned with axes 62, therefore links 18a and 18b rotate about axes 62 while geared portions 56 of links 18a and 18b are rotatably connected to each other. In view of the foregoing, it should be appreciated that movement of link 18a causes movement of link 18b based on the gear relationship between the two links. In other words, when the geared portions 56 of links 18a and 18b are matched, i.e., geared portions 56 on each of links 18a and 18b are identical, the rotational rate of each of links 18a and 18b is the same. Moreover, when the geared portions 56 of links 18a and 18b are not matched, i.e., geared portions 56 on each of links 18a and 18b comprise different diameters, and therefore different numbers of teeth, the rotational rate of each of links 18a and 18b is different. At a second end of each of links 18a and 18b, i.e., end 64, through holes 66a and 66b are disposed in side walls 52a and 52b, respectively, wherein through holes 66a and 66b are in registered alignment. Each of through holes 66a and 66b are aligned with axes 68.

Links 20a and 20b each include spaced apart parallel side walls 70a and 70b. At a first end of each of links 20a and 20b, i.e., end 72, through holes 74a and 74b are disposed in side walls 70a and 70b, respectively, wherein through holes 74a and 74b are in registered alignment. Each of through holes 74a and 74b are aligned with axes 76, therefore links 20a and 20b are permitted to rotate about axes 76. At a second end of each of links 20a and 20b, i.e., end 78, through holes 80a and 80b are disposed in side walls 70a and 70b, respectively, wherein through holes 80a and 80b are in registered alignment. Each of through holes 80a and 80b are aligned with axes 82, therefore links 20a and 20b are permitted to rotate about axes 82.

Rear mounting plate 12 comprises spaced part parallel side walls 84a and 84b wherein through holes 86a and 86b are respectively disposed and through holes 88a and 88b are respectively disposed. Through holes 86a and 86b are in registered alignment, while through holes 88a and 88b are in registered alignment. Each of through holes 86a and 86b are aligned with axes 90, while each of through holes 88a and 88b are aligned with axes 92. Swivel assembly 16 comprises front pivot link 22 and front mounting plate 24. Front pivot link 22 comprises spaced part parallel side walls 94a and 94b wherein through holes 96a and 96b are respectively disposed and through holes 98a and 98b are respectively disposed. Through holes 96a and 96b are in registered alignment, while through holes 98a and 98b are in registered alignment. Each of through holes 96a and 96b are aligned with axes 100, while each of through holes 98a and 98b are aligned with axes 102. Front mounting plate 24 is pivotably secured to front pivot link 22 such that front mounting plate 24 may pivot about axis 50.

As shown in the first embodiment, through holes 60a and 60b of link 18a are in registered alignment with through holes 86a and 86b, while through holes 60a and 60b of link 18b are in registered alignment with through holes 88a and 88b. Similarly, through holes 66a and 66b of link 18a are in registered alignment with through holes 74a and 74b of link 20a, while through holes 66a and 66b of link 18b are in registered alignment with through holes 74a and 74b of link 20b. Lastly, through holes 80a and 80b of link 20a are in registered alignment with through holes 96a and 96b, while through holes 80a and 80b of link 20b are in registered alignment with through holes 98a and 98b. As can be seen in FIGS. 3A-4E, the aligned through holes are secured to each other using rivets, bolts, or other suitable fasteners known in the art.

The arrangement of the first embodiment permits the following degrees of freedom. As swivel mount 16 is moved inwardly and outwardly with respect to rear mounting plate 12, links 18a and 18b simultaneously rotate in accordance with the arrangement of the respective gears 56 of each of links 18a and 18b. Once partially or fully extended, swivel mount 16 may be rotated and translated about arcuate bi-directional arrow 48. During such rotation and translation, links 18a and 18b rotate slightly about axes 62, while links 20a and 20b rotate about axes 76 and 82. Front mounting plate 24 may rotate about axis 50. Furthermore, the movement of front mounting plate 24 relative to front pivot link 22 may be releasably secured by locking apparatus 103. Locking apparatus 103 comprises bolt 34 and nut 36. As can be appreciated in view of the figures, the tightening of nut 36 on bolt 34 causes front mounting plate 24 to frictionally engage front pivot link 22 thereby releasably securing plate 24 relative to link 22.

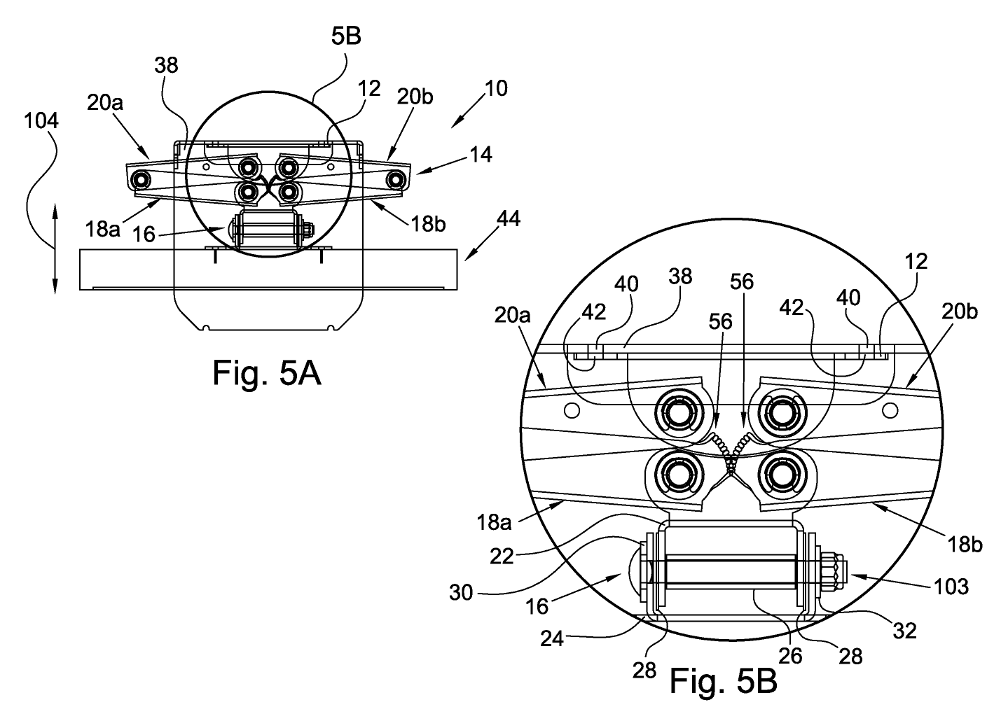

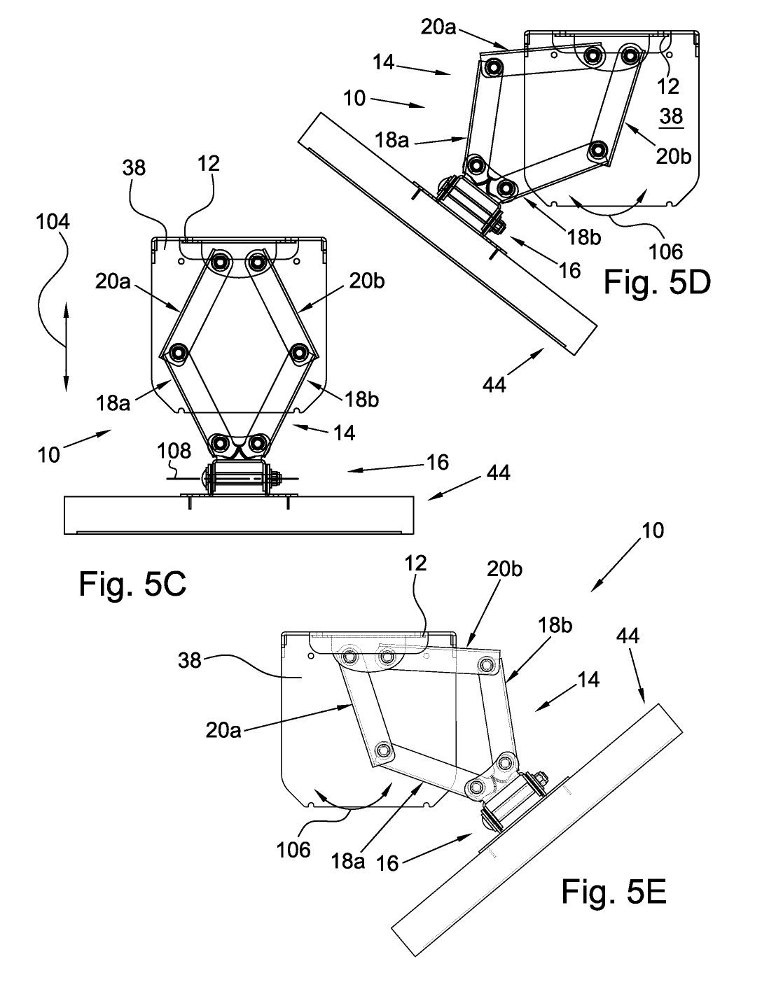

A second embodiment is shown in FIGS. 5A-5E wherein swivel assembly 16 may be moved inwardly and outwardly in the directions represented by bi-directional arrow 104, may pivot, or more particularly rotate and translate, side to side about arcuate bi-directional arrow 106 located proximate swivel assembly 16, and may pivot upwardly and downwardly about axis 108. Such degrees of freedom are provided by the arrangement of links 18a, 18b, 20a and 20b.

As shown in the second embodiment, through holes 74a and 74b of link 20a are in registered alignment with through holes 86a and 86b, while through holes 74a and 74b of link 20b are in registered alignment with through holes 88a and 88b. Similarly, through holes 80a and 80b of link 20a are in registered alignment with through holes 66a and 66b of link 18a, while through holes 80a and 80b of link 20b are in registered alignment with through holes 66a and 66b of link 18b. Lastly, through holes 60a and 60b of link 18a are in registered alignment with through holes 96a and 96b, while through holes 60a and 60b of link 18b are in registered alignment with through holes 98a and 98b. As can be seen in FIGS. 5A-5E, the aligned through holes are secured to each other using rivets, or other suitable fasteners known in the art.

The arrangement of the second embodiment permits the following degrees of freedom. As swivel mount 16 is moved inwardly and outwardly with respect to rear mounting plate 12, links 18a and 18b simultaneously rotate in accordance with the arrangement of the respective gears 56 of each of links 18a and 18b. Once partially or fully extended, swivel mount 16 may be rotated and translated about arcuate bi-directional arrow 106. During such rotation and translation, links 18a and 18b rotate slightly about axes 62, while links 20a and 20b rotate about axes 76 and 82. Front mounting plate 24 may rotate about axis 108. Furthermore, the movement of front mounting plate 24 relative to front pivot link 22 may be releasably secured by locking apparatus 103. Locking apparatus 103 comprises bolt 34 and nut 36. As can be appreciated in view of the figures, the tightening of nut 36 on bolt 34 causes front mounting plate 24 to frictionally engage front pivot link 22 thereby releasably securing plate 24 relative to link 22.

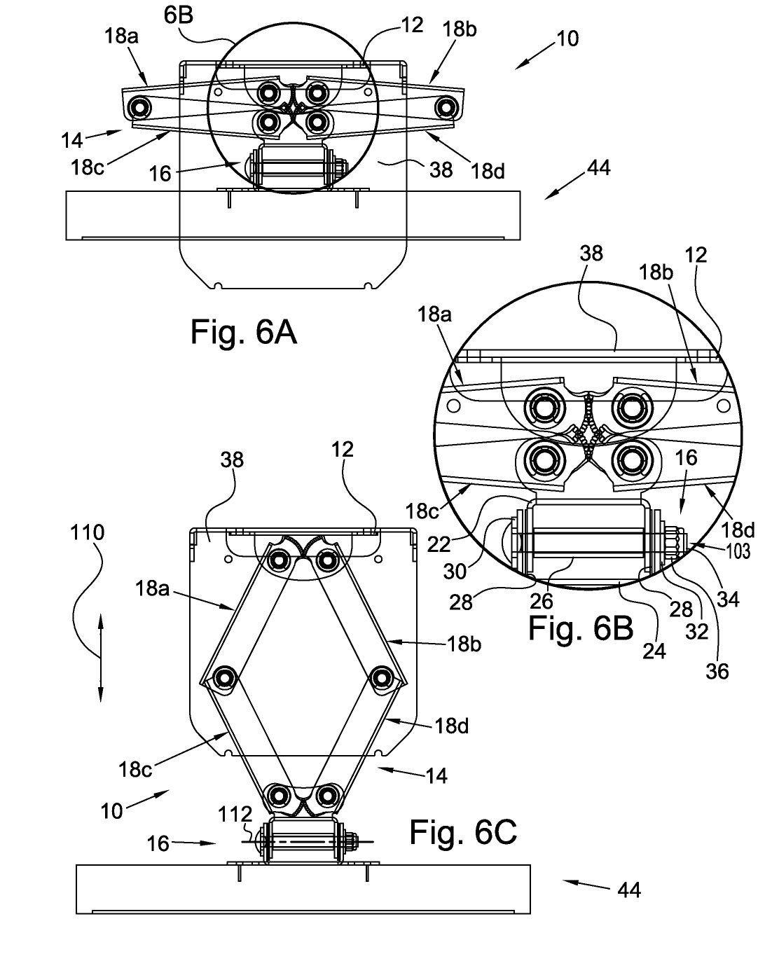

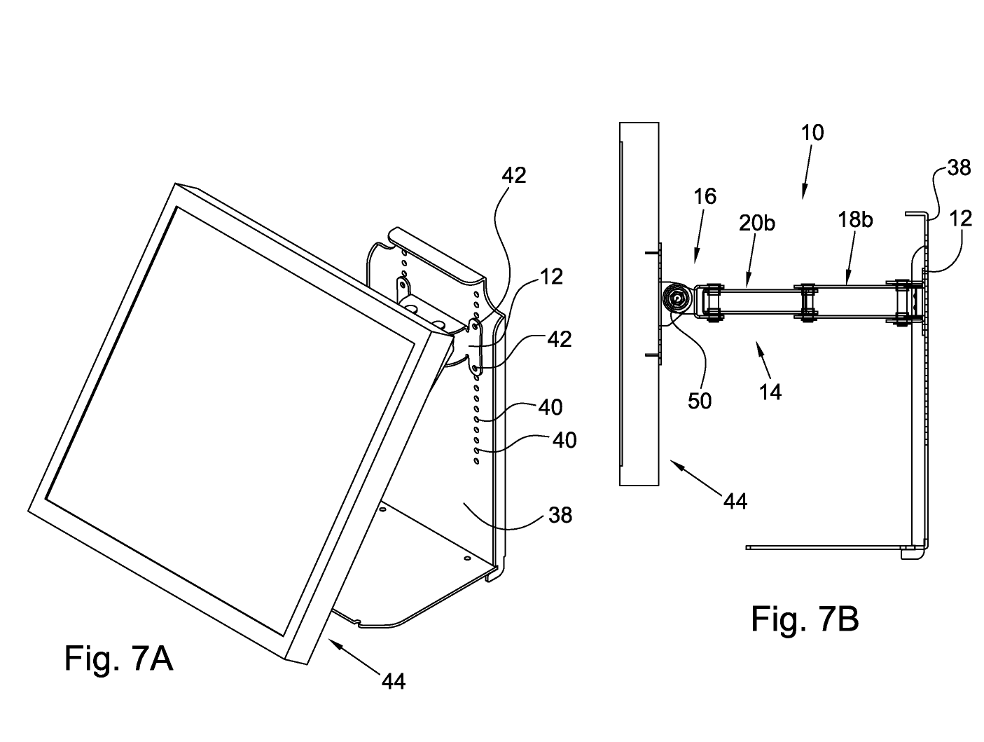

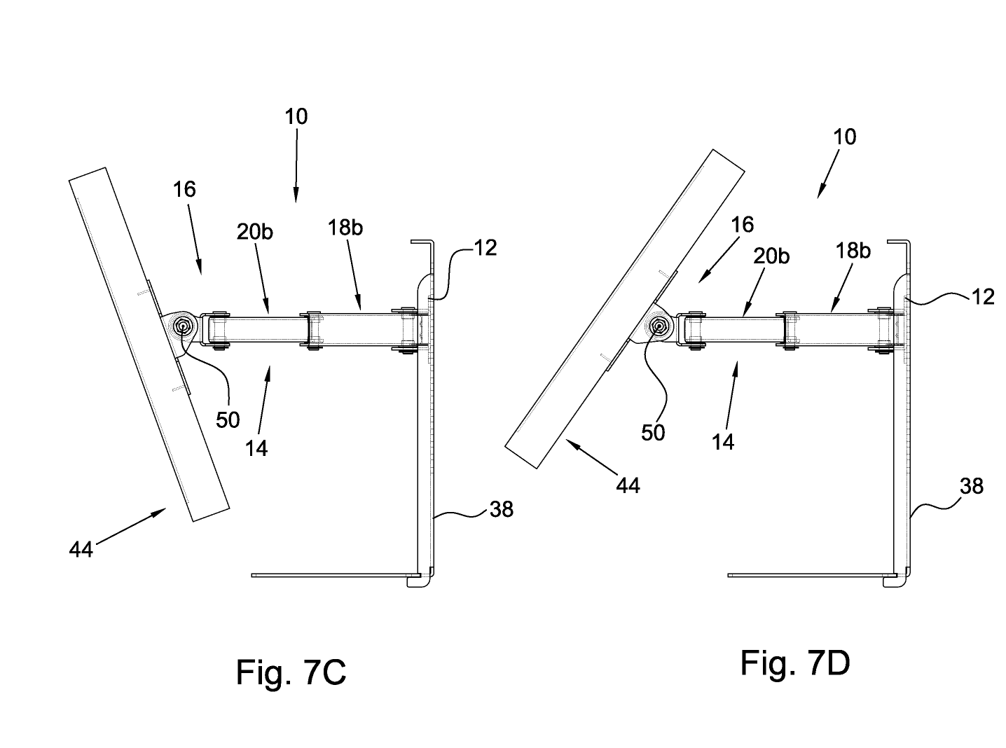

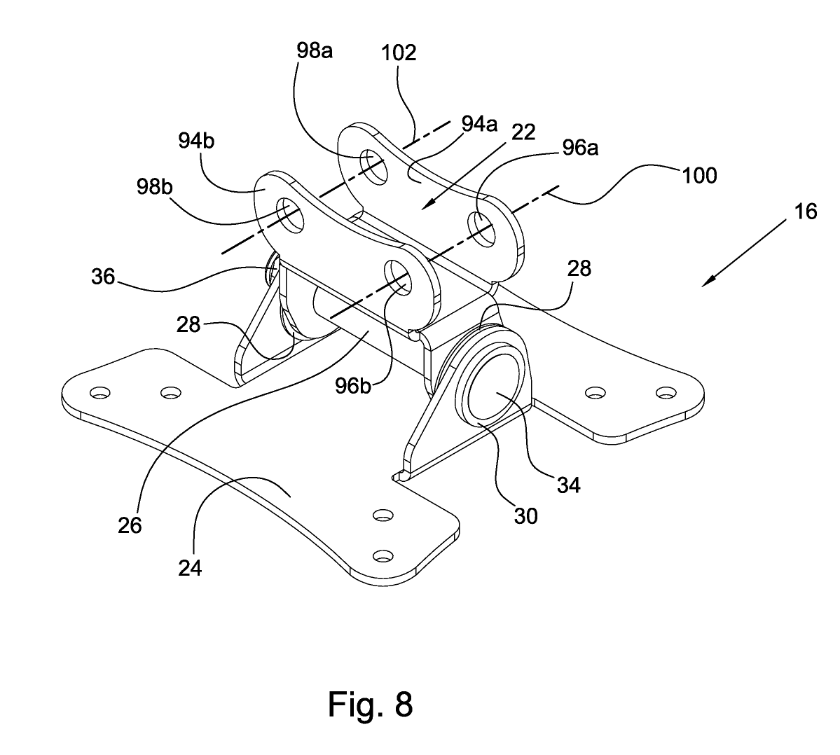

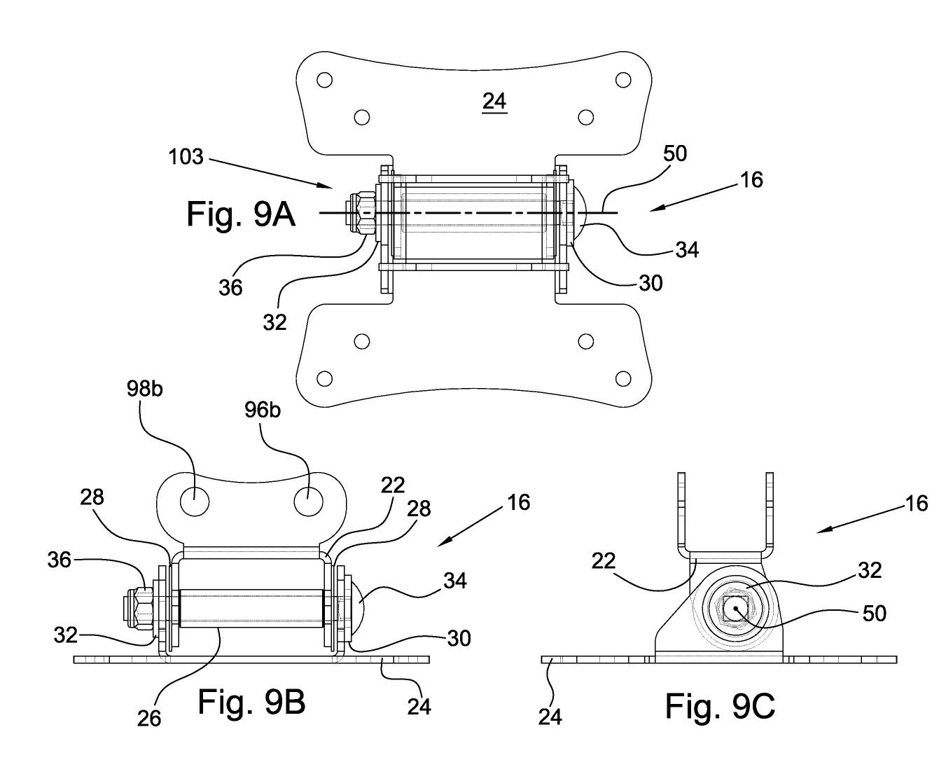

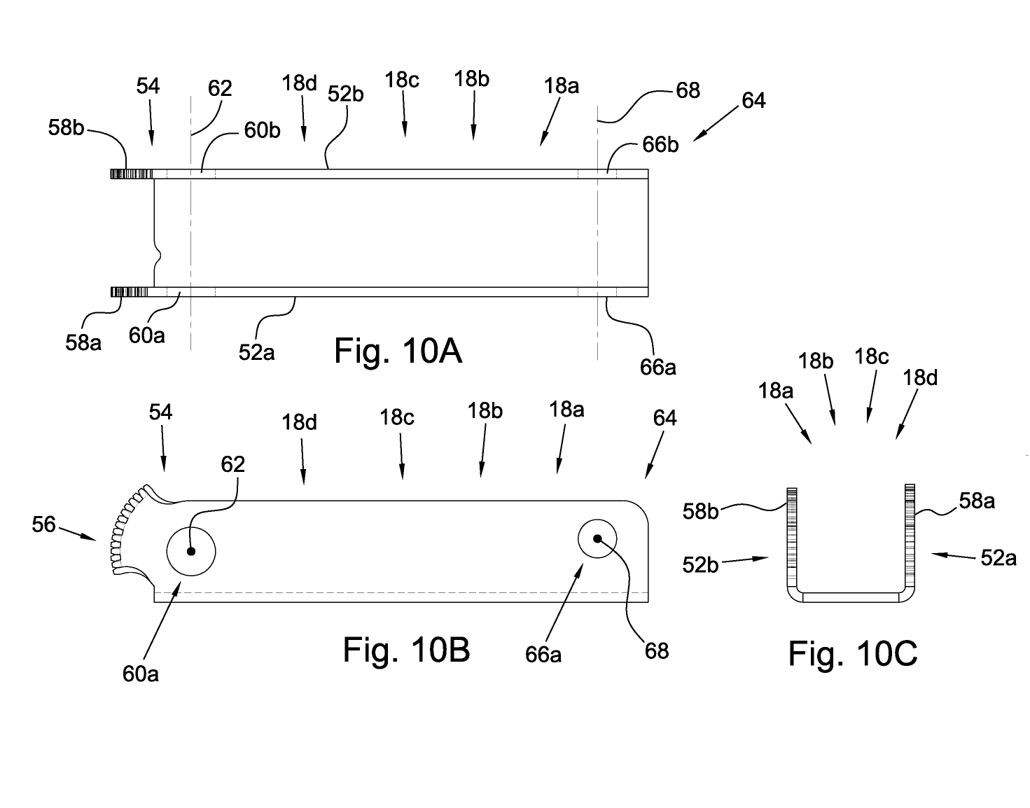

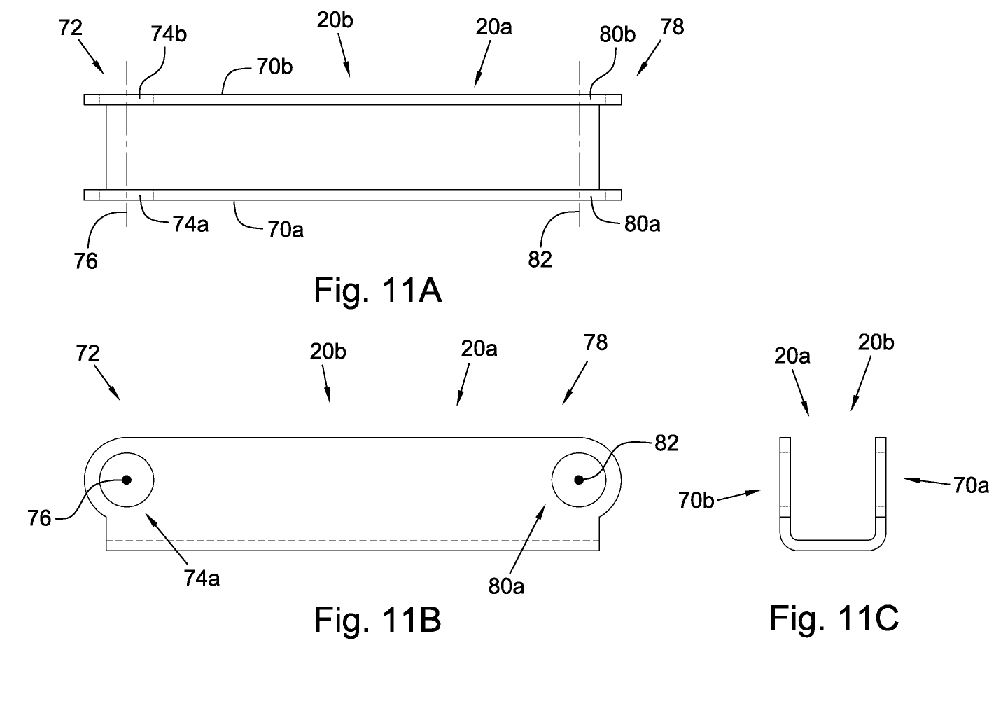

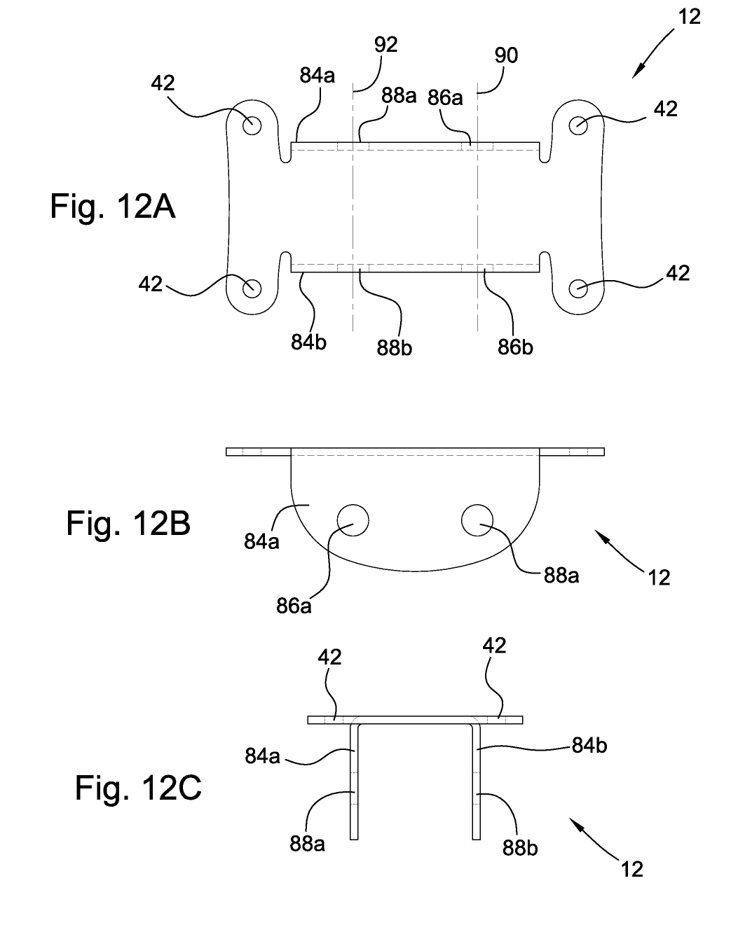

A third embodiment is shown in FIGS. 6A-6C wherein swivel assembly 16 may be moved inwardly and outwardly in the directions represented by bi-directional arrow 110 and may pivot upwardly and downwardly about axis 112. Such degrees of freedom are provided by the arrangement of links 18a, 18b, 18c and 18d. It should be appreciated that links 18c and 18d are identical in arrangement to links 18a and 18b; however, as shown in FIGS. 6A-6C, the distance between spaced apart parallel side walls 52a and 52b of links 18c and 18d is slightly smaller than the distance between spaced apart parallel side walls 52a and 52b of links 18a and 18b so that links 18c and 18d are permitted to fit within links 18a and 18b.

As shown in the third embodiment, through holes 60a and 60b of link 18a are in registered alignment with through holes 86a and 86b, while through holes 60a and 60b of link 18b are in registered alignment with through holes 88a and 88b. Similarly, through holes 66a and 66b of link 18a are in registered alignment with through holes 66a and 66b of link 18c, while through holes 66a and 66b of link 18b are in registered alignment with through holes 66a and 66b of link 18d. Lastly, through holes 60a and 60b of link 18c are in registered alignment with through holes 96a and 96b, while through holes 60a and 60b of link 18d are in registered alignment with through holes 98a and 98b. As can be seen in FIGS. 6A-6C, the aligned through holes are secured to each other using rivets, or other suitable fasteners known in the art.

The arrangement of the third embodiment permits the following degrees of freedom. As swivel mount 16 is moved inwardly and outwardly with respect to rear mounting plate 12, links 18a and 18b simultaneously rotate in accordance with the arrangement of the respective gears 56 of each of links 18a and 18b, while links 18c and 18d simultaneously rotate in accordance with the arrangement of the respective gears 56 of each of links 18c and 18d. Once partially or fully extended, swivel mount 16 it precluded from the rotation and translation described above with respect to the first and second embodiments. Front mounting plate 24 may rotate about axis 112. Furthermore, the movement of front mounting plate 24 relative to front pivot link 22 may be releasably secured by locking apparatus 103. Locking apparatus 103 comprises bolt 34 and nut 36. As can be appreciated in view of the figures, the tightening of nut 36 on bolt 34 causes front mounting plate 24 to frictionally engage front pivot link 22 thereby releasably securing plate 24 relative to link 22.

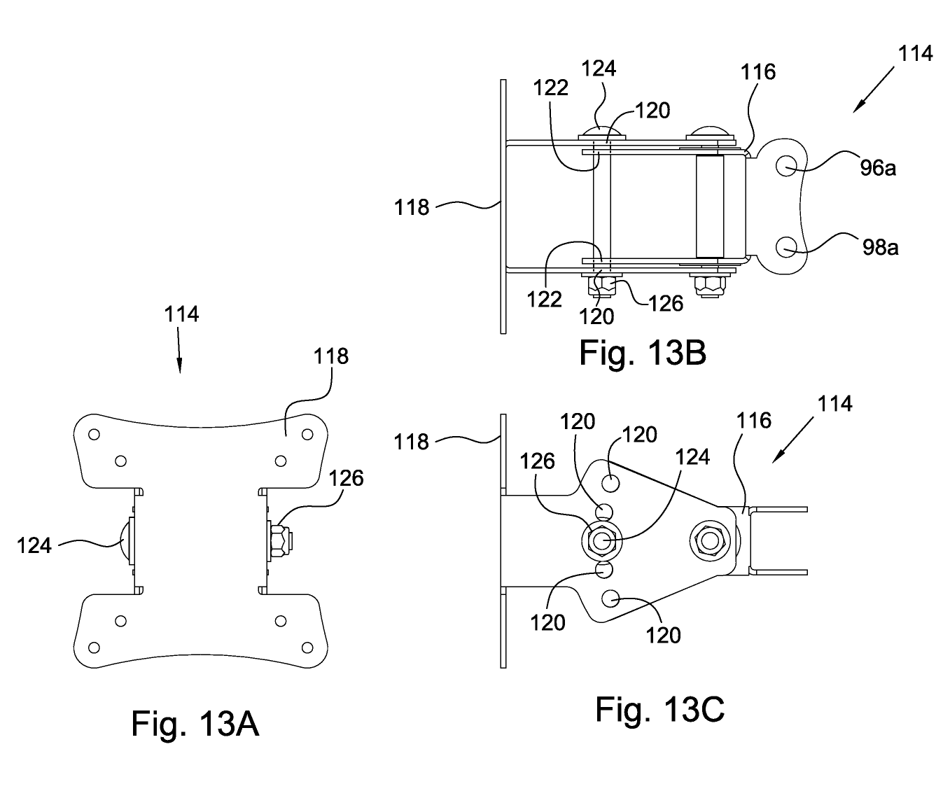

It should be appreciated that the locking apparatus arranged to releasably secure front mounting plate 24 relative to front pivot link 22 may be provided by a variety of embodiments, e.g., locking apparatus 103. A further embodiment of such a locking apparatus is shown in FIGS. 13A through 13C. Swivel assembly 114 comprises front pivot link 116 and front mounting plate 118. Front mounting plate 118 comprises a plurality of pairs of oppositely disposed through holes 120 while front pivot link 116 comprises pair of oppositely disposed through holes 122. Based on the desired viewing angle of the object mounting on the swivel assembly, a particular pair of the plurality of pairs of oppositely disposed through holes 120 may be aligned with pair of oppositely disposed through holes 122. Pin or bolt 124 is disposed within one of the pairs of the plurality of pairs of oppositely disposed through holes 120 and pair of oppositely disposed through holes 122 thereby preventing pivotal movement of front pivot link 116 relative to front mounting plate 118. In this embodiment, bolt 124 is secured within the aligned through holes by nut 126. Although bolt 124 and nut 126 are shown in FIGS. 13A through 13C as a locking apparatus, the embodiment depicted therein may also use a pin, a pin in combination with a retaining clip or other means known in the art to prevent relative pivotal movement between front pivot link 116 and front mounting plate 118, and such alternate embodiments are within the spirit and scope of the claims.

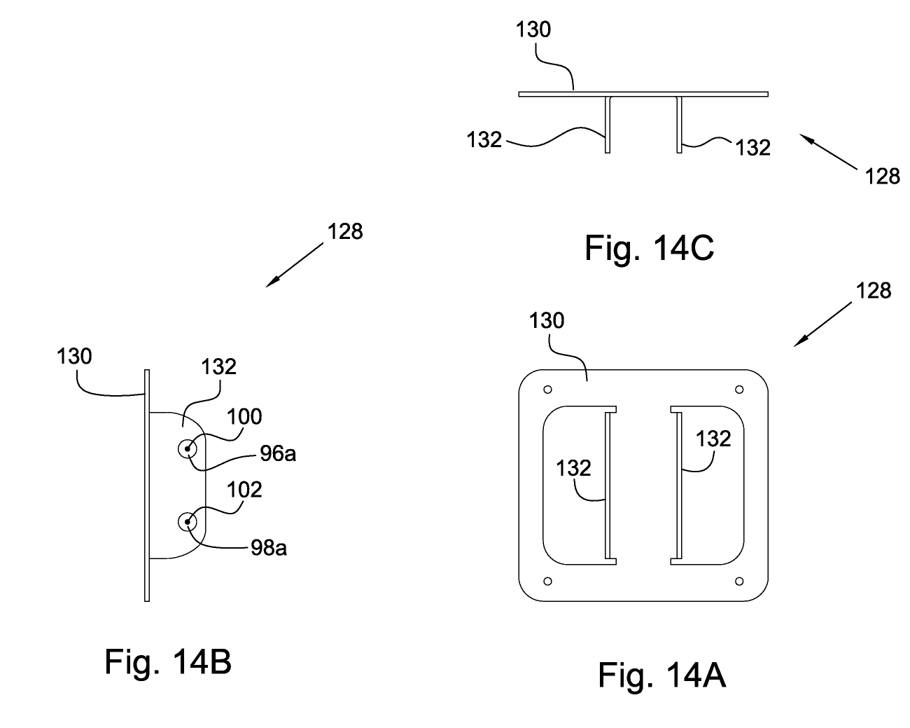

It should be further appreciated that some embodiments of the present invention scissor linkage mechanism may comprise a swivel assembly which is a single article, e.g., swivel assembly 128 depicted in FIGS. 14A through 14C. In this embodiment, the object mounted on swivel assembly 128, e.g., flat screen monitor 44, is secured to front surface 130 while links 18c and 18d or links 20a and 20b are pivotably secured to oppositely disposed side walls 132. Thus, a present invention scissor linkage mechanism comprising swivel assembly 128 will provide all degrees of freedom of movement present within the linkage mechanism except upward and downward movement of the object mounted on swivel assembly 128.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

1. A mounting apparatus for an object comprising:
a rear mounting plate;
a linkage system comprising first, second, third and fourth links, each of the first, second, third and fourth links comprises first and second ends; and,
a swivel assembly, the first end of each of the first and second links is pivotably secured to the rear mounting plate, the second end of each of the third and fourth links is pivotably secured to the swivel assembly, the second end of the first link is pivotably secured to the first end of the third link, the second end of the second link is pivotably secured to the first end of the fourth link, wherein the first end of the first link comprises a first gear and the first end of the second link comprises a second gear, and the first gear is rotatably connected to the second gear.

2. The mounting apparatus of claim 1, wherein the object is secured to the swivel assembly.

3. The mounting apparatus of claim 1, wherein the object is selected from the group consisting of: a flat screen television, a computer monitor, a touch screen device and a generally planar object.

4. The mounting apparatus of claim 1, wherein the swivel assembly comprises a front pivot link pivotably secured to a front mounting plate and the second end of each of the third and fourth links is pivotably secured to the front pivot link.

5. The mounting apparatus of claim 4, wherein the swivel assembly comprises a locking apparatus for releasably securing the front pivot link relative to the front mounting plate.

6. The mounting apparatus of claim 5, wherein the locking apparatus comprises a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

7. A mounting apparatus for an object comprising:
a rear mounting plate;
a linkage system comprising first, second, third and fourth links, each of the first, second, third and fourth links comprises first and second ends; and,
a swivel assembly, the first end of each of the first and second links is pivotably secured to the rear mounting plate, the second end of each of the third and fourth links is pivotably secured to the swivel assembly, the second end of the first link is pivotably secured to the first end of the third link, the second end of the second link is pivotably secured to the first end of the fourth link, wherein the second end of the third link comprises a first gear and the second end of the fourth link comprises a second gear, and the first gear is rotatably connected to the second gear.

8. The mounting apparatus of claim 7, wherein the object is secured to the swivel assembly.

9. The mounting apparatus of claim 7, wherein the object is selected from the group consisting of: a flat screen television, a computer monitor, a touch screen device and a generally planar object.

10. The mounting apparatus of claim 7, wherein the swivel assembly comprises a front pivot link pivotably secured to a front mounting plate and the second end of each of the third and fourth links is pivotably secured to the front pivot link.

11. The mounting apparatus of claim 10, wherein the swivel assembly comprises a locking apparatus for releasably securing the front pivot link relative to the front mounting plate.

12. The mounting apparatus of claim 11, wherein the locking apparatus comprises a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

13. A mounting apparatus for an object comprising:
a rear mounting plate;
a linkage system comprising first, second, third and fourth links, each of the first, second, third and fourth links comprises first and second ends; and,
a swivel assembly, the first end of each of the first and second links is pivotably secured to the rear mounting plate, the second end of each of the third and fourth links is pivotably secured to the swivel assembly, the second end of the first link is pivotably secured to the first end of the third link, the second end of the second link is pivotably secured to the first end of the fourth link, wherein the first end of the first link comprises a first gear, the first end of the second link comprises a second gear, the second end of the third link comprises a third gear, the second end of the fourth link comprises a fourth gear, the first gear is rotatably connected to the second gear and the third gear is rotatably connected to the fourth gear.

14. The mounting apparatus of claim 13, wherein the object is secured to the swivel assembly.

15. The mounting apparatus of claim 13, wherein the object is selected from the group consisting of: a flat screen television, a computer monitor, a touch screen device and a generally planar object.

16. The mounting apparatus of claim 13, wherein the swivel assembly comprises a front pivot link pivotably secured to a front mounting plate and the second end of each of the third and fourth links is pivotably secured to the front pivot link.

17. The mounting apparatus of claim 16, wherein the swivel assembly comprises a locking apparatus for releasably securing the front pivot link relative to the front mounting plate.

18. The mounting apparatus of claim 17, wherein the locking apparatus comprises a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.

19. A mounting apparatus for an object comprising:
a rear mounting plate;
a linkage system comprising first, second, third and fourth links, each of the first, second, third and fourth links comprises first and second ends; and,
a swivel assembly, the first end of each of the first and second links is pivotably secured to the rear mounting plate, the second end of each of the third and fourth links is pivotably secured to the swivel assembly, the second end of the first link is pivotably secured to the first end of the third link, the second end of the second link is pivotably secured to the first end of the fourth link, wherein the linkage system comprises a first gear and a second gear, and the first gear is rotatably connected to the second gear.

20. The mounting apparatus of claim 19, wherein the first end of the first link comprises the first gear and the first end of the second link comprises the second gear.

21. The mounting apparatus of claim 19, wherein the second end of the third link comprises the first gear and the second end of the fourth link comprises the second gear.

22. The mounting apparatus of claim 19, wherein the linkage system further comprises a third gear and a fourth gear, the third gear is rotatably connected to the fourth gear, the first end of the first link comprises the first gear, the first end of the second link comprises the second gear, the second end of the third link comprises the third gear and the second end of the fourth link comprises the fourth gear.

23. The mounting apparatus of claim 19, wherein the object is secured to the swivel assembly.

24. The mounting apparatus of claim 19, wherein the object is selected from the group consisting of: a flat screen television, a computer monitor, a touch screen device and a generally planar object.

25. The mounting apparatus of claim 19, wherein the swivel assembly comprises a front pivot link pivotably secured to a front mounting plate and the second end of each of the third and fourth links is pivotably secured to the front pivot link.

26. The mounting apparatus of claim 25, wherein the swivel assembly comprises a locking apparatus for releasably securing the front pivot link relative to the front mounting plate.

27. The mounting apparatus of claim 26, wherein the locking apparatus comprises a plurality of first pairs of oppositely disposed through holes arranged within the front mounting plate, a second pair of oppositely disposed through holes arranged within the front pivot link and a pin disposed within one of the plurality of first pairs of oppositely disposed through holes and the second pair of oppositely disposed through holes.
